(19) United States
(12) Patent Application Publication
(10) Pub. No.: US 2026/0220713 A1
(43) Pub. Date: Jul. 30, 2026

(54) METHOD AND SYSTEM FOR ASSET PORTFOLIO FORECASTING

(71) Applicant: LG MANAGEMENT DEVELOPMENT INSTITUTE CO., LTD., Seoul (KR)

(72) Inventors: Min Jae KIM, Gyeonggi-do (KR); Tae Yoon LIM, Seoul (KR); Jung Hee KIM, Seoul (KR); Won Bin AHN, Seoul (KR)

(21) Appl. No.: 19/575,935

(22) Filed: Mar. 24, 2026

Related U.S. Application Data
(63) Continuation of application No. PCT/KR2025/011891, filed on Aug. 7, 2025.

(30) Foreign Application Priority Data
Aug. 16, 2024 (KR) 10-2024-0110081
Aug. 4, 2025 (KR) 10-2025-0106471

(51) Int. Cl. G06Q 40/06; G06N 20/00

(52) U.S. Cl. CPC G06Q 40/063; G06N 20/00

(57) ABSTRACT

An asset portfolio prediction method performed by a computing system comprise determining a target prediction task which is data specifying an objective task; collecting raw data to perform the determined target prediction task; aligning the collected raw data in a time-series on a specific time axis; training a predetermined time-series prediction model based on the aligned raw data and the determined target prediction task; predicting daily portfolio asset weight data over a predetermined prediction unit period based on the trained time-series prediction model; generating a single set of portfolio asset weight data by processing the predicted daily portfolio asset weight data at each predetermined rebalancing time; and providing the generated single set of portfolio asset weight data.

### CROSS-REFERENCE TO RELATED APPLICATIONS

This application is a continuation of International Patent Application No. PCT/KR2025/011891, filed on Aug. 7, 2025, which claims the benefit of and priority to Korean Patent Application No. 10-2024-0110081, filed on Aug. 16, 2024, and Korean Patent Application No. 10-2025-0106471, filed on Aug. 4, 2025, the entire disclosures of which are hereby incorporated herein by reference in their entireties.

### BACKGROUND

### Field

The present disclosure generally relates to an asset portfolio prediction method and system. More specifically, some embodiments of the present disclosure relate to a method and system for predicting asset portfolio weights based on adjustable objectives and diversified data.

### Description of Related Art

In a financial investment environment, it is critically important to ensure the prediction accuracy and stability of portfolio asset allocation and alignment with an investment objective.

However, traditional ways of constructing a portfolio (e.g., a mean-variance optimization (MVO) approach) rely on past data to compute a covariance matrix and calculate a weight of each asset through an inverse matrix operation. This can lead to numerical instability in the covariance matrix depending on a data collection period or market volatility.

In addition, statistical regression models based on historical returns or machine learning-based models that rely on limited feature sets have limitations in that they have difficulty in promptly adapting to abrupt changes in market conditions or unexpected macroeconomic variables, resulting in an accumulation of prediction errors and ultimately degradation of portfolio management outcomes.

Moreover, conventional portfolio optimization models typically focus on predicting future returns and determining asset weights based solely on those predictions. As a result, such models do not directly provide time-series predictions indicating how asset weights of assets should be adjusted at each rebalancing cycle in practical investment management, which can limit the formulation of practical rebalancing strategies.

Without comprehensive consideration of changes and trends in predicted asset weights, it becomes difficult to achieve consistent and stable asset allocation and to respond effectively to unexpected market risks.

Besides, existing prediction models often fail to provide investors or managers with sufficient supporting information to verify the reliability of prediction results (e.g., identification of variables that contributed to the prediction), thereby making it difficult to ensure reliability of the prediction results when such results are applied to actual investment strategies.

In addition, it is necessary to run user-customized scenarios (e.g., what-if simulations) to flexibly adjust investment strategies in response to specific events or variable changes.

However, the existing systems may lack the capability to instantly perform re-predictions and provide supporting data based on such changes of assumptions, thereby hindering the efficiency of decision-making by investors.

Furthermore, conventional approaches may be inadequate in terms of feedback loop structures which continuously monitor the outcomes of predicted asset weights on a rebalancing cycle basis and renew or update the model based on the outcomes. This limitation reduces the model's adaptability to market changes and undermines the long-term stability of management outcomes.

Accordingly, some embodiments of the present disclosure may aim to overcome the limitations of the existing technologies by introducing an enhanced technological paradigm that dynamically predicts asset portfolio weights based on adjustable objectives and diversified data, provide a basis for the predictions, and evaluate corresponding management outcomes to perform model feedback updates.

### SUMMARY

Certain embodiments of the present disclosure may address the above-described problems of the related art, and may provide a method and system for predicting asset portfolio weights through a temporal fusion transformer (TFT)-based deep learning model by utilizing adjustable objectives and diversified data.

However, technical objects to be achieved by the present disclosure and the embodiments of the present disclosure are not limited to those as described above, and other technical aspects are provided below.

An embodiment of the present disclosure provides an asset portfolio prediction method performed by a computing system, the method comprising: determining a target prediction task which is data specifying an objective task; collecting raw data to perform the determined target prediction task; aligning the collected raw data in a time-series on a specific time axis; training a predetermined time-series prediction model based on the aligned raw data and the determined target prediction task; predicting daily portfolio asset weight data over a predetermined prediction unit period based on the trained time-series prediction model; generating a single set of portfolio asset weight data by processing the predicted daily portfolio asset weight data at each predetermined rebalancing time; and providing the generated single set of portfolio asset weight data.

In another aspect, the determining of a target prediction task comprises obtaining task configuration information which includes at least two of the following data elements: a predetermined domain, current portfolio asset weights, a rebalancing period, an asset pool, and investment style data.

In another aspect, the investment style data includes data that specifies at least one of the following styles: a return-maximizing tendency, which allocates weights to assets with positive(+) cumulative historical returns; a risk-minimizing style, which allocates weights to assets with low historical volatility; and a Sharpe ratio optimization style, which allocates weights in descending order of each asset's Sharpe ratio.

In another aspect, the collecting of raw data comprises collecting at least one of the following types of data: predetermined time-series price data, macroeconomic indicator data, market indicator data, and target-influencing variable data.

In another aspect, the target-influencing variable data is variables that have a correlation of a predetermined value or higher with at least one of a domain and asset data corresponding the target prediction task.

In another aspect, the aligning of the raw data in a time-series on a specific time axis comprises aligning the task configuration information corresponding to the target prediction task on the time axis, along with the raw data.

In another aspect, the training of a time-series prediction model comprises: inputting, into the time-series model, time-series data from a predetermined time point t-p to a predetermined time point t, out of a training dataset including the raw data aligned in a time-series and the task configuration information; predicting the daily portfolio asset weight data from a predetermined time point t+1 to a predetermined time point t+h by the time-series prediction model into which the time-series data has been inputted; performing normalization post-processing on each of the predicted daily portfolio asset weight data so that the sum of asset weights included in the portfolio asset weight data equals ‘1’; comparing the normalized daily portfolio asset weight data with actual daily portfolio asset weight data from the predetermined time point t+1 to the predetermined time point t+h; calculating a loss based on a result of the comparison; and updating parameters of the time-series prediction model based on the calculated loss.

In another aspect, the predicting of daily portfolio asset weight data over a prediction unit period comprises performing normalization post-processing on each of the predicted daily portfolio asset weight data so that the sum of asset weights included in the portfolio asset weight data equals ‘1’

In another aspect, the generating of a single set of portfolio asset weight data comprises: applying at least one rule to the daily portfolio asset weight data, the at least one rule including a rule that applies a predetermined operation to the daily portfolio asset weight data and a rule that determines whether the daily portfolio asset weight data satisfies a predefined criterion;

and generating the single set of portfolio asset weight data based on a result of applying the rule.

In another aspect, the generating of a single set of portfolio asset weight data further comprises, if there are certain transaction costs and asset weight constraints, selectively applying at least one of predetermined clipping and smoothing operations to generate the single set of portfolio weight asset data.

In another aspect, the asset portfolio prediction method further comprises providing supporting data which is data that explains the causal relationships and data flow based on which the single set of portfolio asset weight data is determined.

In another aspect, the asset portfolio prediction method further comprises: evaluating the performance of the time-series prediction model based on actual investment outcomes from the single set of portfolio asset weight data; and updating parameters of the time-series prediction model according to a result of the evaluation.

In another aspect, the asset portfolio prediction method further comprises: obtaining a target label dataset, which is data generated from daily portfolio asset weight data corresponding to a prediction period of the time-series prediction model, based on a predetermined existing prediction model; and training the time-series prediction model based on the obtained target label dataset.

In another aspect, the training of the time-series prediction model based on the target label dataset comprises: comparing the daily portfolio asset weight data included in the target label dataset and the daily portfolio asset weight data predicted by the time-series prediction model on a one-on-one basis; calculating a loss based on a result of the comparison; and updating parameters of the time-series prediction model based on the calculated loss.

In another aspect, the obtaining of a target label dataset comprises obtaining objective-specific target label datasets based on existing prediction models optimized for prediction for different given objectives, wherein the training of the time series prediction model based on the target label data set comprises: determining a target label dataset corresponding to a task objective based on at least one of a certain investment style, a market condition, and a domain, among the obtained objective-specific target label datasets; and training the time-series prediction model based on the determined the target label dataset.

In another aspect, the providing of a single set of portfolio asset weight data comprises providing personalized portfolio rebalancing recommendation information based on the single set of portfolio asset weight data via a user interface of a robo-advisor service.

In another aspect, the asset portfolio prediction method further comprises: obtaining a what-if scenario through user input, the scenario assuming changes in a specific macroeconomic indicator or a market indicator; and generating a single set of modified portfolio asset weight data and modified supporting data through the time-series prediction model based on the obtained scenario, and providing the generated data to a fund management support system.

In another aspect, the target prediction task includes a certain investment theme or factor, and the single set of portfolio asset weight data is used as input for determining the constituent portfolio of a new exchange-traded fund (ETF) product.

In another aspect, the training of a time-series prediction model comprises training the time-series prediction model which is a temporal fusion transformer (TFT)-based deep learning model, based on the aligned raw data and the determined target prediction task.

Another embodiment of the present disclosure provides an asset portfolio prediction system comprising: at least one memory; and at least one processor that predicts an asset portfolio by retrieving at least one application stored in the memory, wherein instructions of the processor include instructions for executing the steps of: determining a target prediction task which is data specifying an objective task; collecting raw data to perform the determined target prediction task; aligning the collected raw data in a time-series on a specific time axis; training a predetermined time-series prediction model based on the aligned raw data and the determined target prediction task; predicting daily portfolio asset weight data over a predetermined prediction unit period based on the trained time-series prediction model; generating a single set of portfolio asset weight data by processing the predicted daily portfolio asset weight data at each predetermined rebalancing time; and providing the generated single set of portfolio asset weight data.

In another aspect, the asset portfolio prediction system comprises: a plurality of neurons configured in an array including at least one register, at least one programmable logic, and at least one input interface; a plurality of synapse circuits storing synapse weights that adjust the connection strength between the plurality of neurons; and at least one routing network controlling data flow between the plurality of neurons, wherein each of the plurality of neurons further includes a field programmable gate array (FPGA) implementation for a predetermined artificial neural network connected to at least one other neuron via the routing network to configure a transmission path for the weights.

In another aspect, the asset portfolio prediction system comprises: a plurality of neurons configured in an array including at least one register, at least one microprocessor, and at least one input; and a plurality of synapse circuits storing synapse weights that adjust the connection strength between the plurality of neurons, wherein each of the plurality of neurons further includes an application specific integrated circuit (ASIC) for a predetermined artificial neural network connected to at least one other neuron via one of the plurality of synapse circuits.

An asset portfolio prediction method and system according to an embodiment of the present disclosure can establish and provide an optimal rebalancing strategy that flexibly responds to changes in market conditions and aligns with an investment goal, by predicting asset portfolio weights through a temporal fusion transformer (TFT)-based deep learning model.

The effects of the present disclosure are not limited to the foregoing, and other effects not mentioned herein will be able to be clearly understood by those skilled in the art from the following description.

### BRIEF DESCRIPTION OF THE DRAWINGS

FIG. 1 illustrates a block diagram of a computing system for implementing an asset portfolio prediction service according to an embodiment of the present disclosure.

FIG. 2 illustrates a block diagram of a computing device for implementing an asset portfolio prediction service according to an embodiment of the present disclosure.

FIG. 3 illustrates a block diagram of a computing device for implementing an asset portfolio prediction service according to an embodiment of the present disclosure.

FIG. 4 illustrates a flowchart for explaining an asset portfolio prediction method according to an embodiment of the present disclosure.

FIG. 5 illustrates a conceptual diagram of a time-series prediction model-based portfolio prediction method according to an embodiment of the present disclosure and a conventional portfolio construction method.

FIG. 6 illustrates examples of portfolio weight prediction results across various sectors from a time-series prediction update model according to one embodiment of the present disclosure.

FIG. 7 illustrates a graph comparing outcomes of various portfolio management methods based on cumulative returns, which demonstrate that a portfolio weight prediction method according to an embodiment of the present disclosure which reflected a predetermined external indicator (variable) achieved superior cumulative-return performance.

### DETAILED DESCRIPTION

As the present disclosure may make various changes and have several embodiments, specific embodiments will be illustrated in a drawing and described in a detailed description. Advantages and features of the present disclosure and methods for achieving them will be made clear from the embodiments described below in detail with reference to the accompanying drawings. The present disclosure may, however, be embodied in many different forms and should not be construed as being limited to the embodiments set forth herein. In the following embodiments, terms such as “first”, “second”, etc., are used to distinguish one component from another component rather than for a restrictive meaning. Singular expressions are intended to include plural expressions unless the context clearly indicates otherwise. Terms such as “include”, “comprise”, or “have” indicate the presence of features or components described in the specification, but do not preclude the possibility of addition of one or more other features or components. In the drawings, the sizes of components may be exaggerated or reduced for convenience of explanation. For example, the sizes and thicknesses of the components shown in the drawings are arbitrarily shown for convenience of explanation, and thus the present disclosure is not necessarily limited to those shown in the drawing.

Hereinafter, embodiments of the present disclosure will be described in detail with reference to the accompanying drawings. When described with reference to the drawings, identical or corresponding components will be given the same reference numerals, and redundant description of these components will be omitted.

### Exemplary Embodiments of Systems for Asset Portfolio Prediction Service

Hereinafter, exemplary embodiments of a system for implementing a service (hereinafter, asset portfolio prediction service) that predicts asset portfolio weights based on adjustable objectives and diversified data will be described in detail with reference to the accompanying drawings.

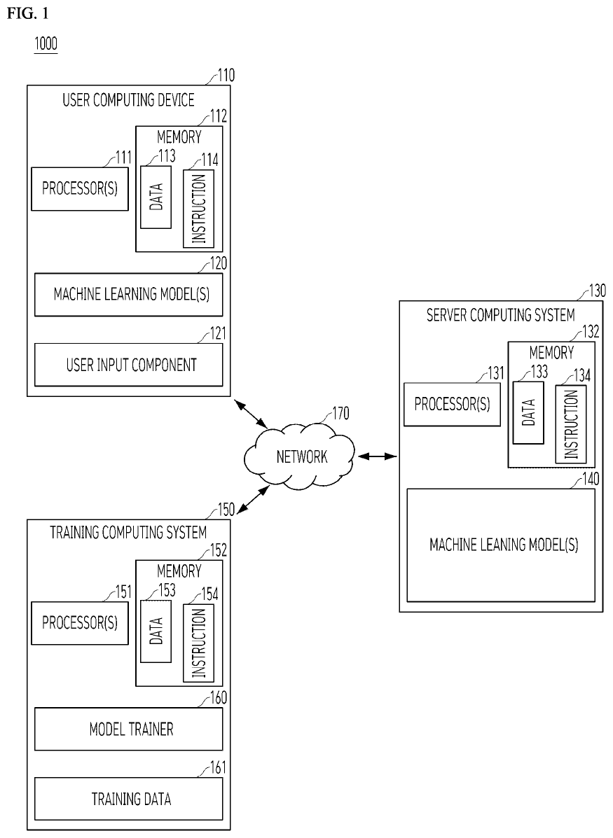

FIG. 1 illustrates a block diagram of a computing system for implementing an asset portfolio prediction service according to an embodiment of the present disclosure.

Referring to FIG. 1, a computing system 1000 that implements an asset portfolio prediction service according to the present disclosure includes a user computing device or a user computer 110, a server computing system or a server 130, and a training computing system or a training computer 150. And, one or more of these devices or systems may be communicatively connected via a network 170.

A method and system for predicting an asset portfolio according to an embodiment of the present disclosure (1) may be implemented and provided locally by the user computing device 110, (2) may be implemented and provided in the form of a web service by the server computing system 130 communicationally connected with the user computing device 110, or (3) may be implemented and provided through interoperation between the user computing device 110 and the server computing system 130.

In an embodiment, the user computing device 110 and/or the server computing system 130 may train a machine learning model 120 and/or 140 through interaction with the training computing system 150 connected communicatively via the network 170. The training computing system 150 may be a system separate from the server computing system 130 or may be a part of the server computing system 130.

An artificial intelligence model may be (1) directly trained locally by the user computing device 110, (2) trained through interaction between the server computing system 130 and the user computing device 110 via the network 170, or (3) trained by the training computing system 150 using various training and learning techniques. In addition, the artificial intelligence model trained by the training computing system 150 may be provided or updated by being transmitted via the network 170 to the user computing device 110 and/or the server computing system 130.

In some embodiments, the training computer system 150 may be a part of the server computing system 130 or a part of the user computing device 110.

### —User Computing Device 110

The user computing device 110 may include any type of computing devices, such as smart phone, mobile phone, digital broadcasting device, personal digital assistant (PDA), portable multimedia player (PMP), desktop computer, wearable device, embedded computing device, and/or tablet personal computer (PC).

Additionally, in the embodiment, the user computing device 110 may further include a predetermined server computing device that provides an asset portfolio prediction service environment.

The user computing device 110 includes at least one processor 111 and memory 112.

The processor 111 of the user computing device 110 may include at least one of a central processing unit (CPU), graphics processing unit (GPU), application-specific integrated circuits (ASICs), digital signal processors (DSPs), digital signal processing devices (DSPDs), programmable logic devices (PLDs), field-programmable gate arrays (FPGAs), controllers, micro-controllers, microprocessors, and/or other electrical units for performing functions or a plurality of electrically or communicationally connected processors.

In particular, in some embodiments, the processor 111 may be configured based on a field programmable gate array (FPGA) implementation and/or an application specific integrated circuit (ASIC) which are hardware technologies for implementing predetermined digital circuits.

Here, the field programmable gate array (FPGA) implementation may refer to a flexible digital circuit that can be programmed according to user needs.

In an embodiment, the FPGA implementation may include: a register, which is configured to temporarily store data and control the flow and timing of signals to maintain intermediate operation results and state information, thereby supporting synchronized FPGA operations; programmable logic, which is logic circuits configurable according to user needs, and which programs operations within the FPGA to perform a specific function or operation; and an input interface, which serves as a channel for receiving data from outside the FPGA, and which receives signals from external devices or sensors and delivers them to an internal circuit.

Through a combination of the aforementioned components, the FPGA implementation may offer flexible and diverse forms of digital circuitry.

The application specific integrated circuit (ASIC) may refer to a customized integrated circuit designed for a particular use or function.

In an embodiment, the ASIC may include: a register, which is a small memory device that temporarily stores and manages data, and stores intermediate operation results or state information to support fast operation of the ASIC; a microprocessor, which is a central processing unit for performing control and operations, and, if necessary, can perform multiple operations or generates a control signal to direct the operation of an overall system; and an input block, which is an interface for taking data from the outside, and receives input data to be processed by the ASIC and transmits to the inside and receives various input data through a connection to a sensor or an external device.

Through a combination of the aforementioned components, the ASIC can perform a task for a specific objective in an optimized manner.

The memory 112 of the user computing device 110 may include one or more non-transitory and/or transitory computer-readable storage media such as Random Access Memory (RAM), Read-Only Memory (ROM), Electrically Erasable Programmable Read-Only Memory (EEPROM), Erasable Programmable Read-Only Memory (EPROM), flash memory devices, and magnetic disks, and combinations thereof, and may include web storage of a server that performs a storage function of the memory on the internet. The memory 112 may store data 113 and instructions 114 required for or executable by at least one processor 111 to perform a functional operation such as training an artificial intelligence model or implementing an asset portfolio prediction service through the artificial intelligence model.

In one embodiment, the user computing device 110 may perform various kinds of deep learning for an asset portfolio prediction service by interoperating with a deep-learning neural network.

For example, the deep learning neural network according to the embodiment may include a convolution neural network (CNN), regions with CNN features (R-CNN), Fast R-CNN, Faster R-CNN, Mask R-CNN, etc., and may include any type of deep learning neural networks which includes an algorithm capable of performing one of embodiments of the present disclosure. The embodiments of the present disclosure are not limited to a specific deep learning neural network.

In some embodiments, the deep learning neural network may be directly installed on the server computing system 130, or may operate as a device separate from the server computing system 130 to perform deep learning for the asset portfolio prediction service.

Additionally, in one embodiment, the user computing device 110 may store one or more machine learning models 120.

For example, the user computing device 110 may include multiple machine learning models such as a plurality of neural networks (e.g., deep neural networks) that perform an asset portfolio prediction method based on structured and/or quantitative data, or other types of machine learning models including non-linear and/or linear models, and may be configured as a combination thereof.

By way of example, the machine learning models may include linear regression, decision trees, random forests, gradient boosted pre-trained language models, or/and deep learning models. The neural networks may include at least one of feed-forward neural networks, recurrent neural networks (e.g., long short-term memory recurrent neural networks), convolutional neural networks, or/and other types of neural networks.

Moreover, in some embodiments, the user computing device 110 may store models to be used in each process and prompt templates that serve as a basis for input into the models, in order to perform at least part of a process performed for an asset portfolio prediction method according to an embodiment of the present disclosure, using a large language model (LLM).

In one embodiment, the user computing device 110 may receive at least one machine learning model 120 from the server computing system 130 via the network 170, store the machine learning model 120 in the memory 112, and execute the stored machine learning model 120 by the processor 111 to perform an asset portfolio prediction service or the like.

In another embodiment, the user computing device 110 may operate in association with the server computing system 130 to perform operations using the machine learning model 140 including at least one machine learning model 140, and may provide an asset portfolio prediction service to the user by transmitting or communicating related data to the outside.

For example, the user computing device 110 may perform an asset portfolio prediction service via the web in such a way that the server computing system 130 provides output in response to the user's input by using the machine learning model 140.

Additionally, an artificial intelligence model may be implemented in such a way that one or more of the machine learning models 120 and/or 140 are executed on the user computing device 110, while the remaining models of the machine learning models 120 and/or 140 are executed on the server computing system 130.

Furthermore, the user computing device 110 may include at least one input component 121 for detecting user input.

For example, the user input component 121 may include a touch sensor (e.g., a touch screen and/or touch pad) configured to detect the touch of a user input medium (e.g., a finger or stylus), an image sensor configured to detect motion input from the user, a microphone configured to detect user voice input, buttons, a mouse, and/or a keyboard.

The image sensor may include an image processing module. Specifically, the image sensor may process still images or video obtained by an image sensor device (e.g., Complementary Metal-Oxide-Semiconductor (CMOS) or Charge-Coupled Device (CCD)).

Additionally, the image sensor may extract necessary information by processing still images or video obtained through the image sensor device using an image recognition process (e.g., Optical Character Recognition (OCR)) and/or the image processing module, and may transmit the extracted information to the processor.

Furthermore, the input component 121 may receive input from external controllers (e.g., mouse, keyboard, etc.) based on an interface module, and may include an external output device (e.g., speaker).

The interface module may include at least one of a wired and/or wireless headset port, an external charger port, a wired/wireless data port, a memory card port, a port for connecting devices equipped with identification modules, an audio input/output (I/O) port, a video input/output (I/O) port, an earphone port, a power amplifier, a radio frequency (RF) circuit, a transceiver, and other communication circuits.

Additionally, the external output device may include a display system that outputs various information related to the asset portfolio prediction service as graphical images.

The display system may be implemented to include at least one of a liquid crystal display (LCD), a thin film transistor-liquid crystal display (TFT LCD), an organic light-emitting diode (OLED), a flexible display, a three-dimensional (3D) display, or an electronic ink (e-ink) display.

The user computing device 110, which includes the aforementioned components, may additionally perform at least a portion of the functional operations that are carried out by the server computing system 130, as described later.

### —Server Computing System 130

The server computing system 130 may perform a series of processes to provide an asset portfolio prediction service.

In detail, in an embodiment, the server computing system 130 may provide an asset portfolio prediction service by exchanging, with an external device such as the user computing device 110, data necessary for running the asset portfolio prediction service process on the external device.

More specifically, in an embodiment, the server computing system 130 may provide an environment in which an application can run on the user computing device 110.

To this end, the server computing system 130 may include an application program, data, and/or instructions necessary for the running of the application, and may transmit and receive various types of data to and from the external device.

Additionally, the server computing system 130 includes at least one processor 131 and memory 132.

Here, the processor 131 of the server computing system 130 may include at least one of a central processing unit (CPU), graphics processing unit (GPU), application-specific integrated circuits (ASICs), digital signal processors (DSPs), digital signal processing devices (DSPDs), programmable logic devices (PLDs), field-programmable gate arrays (FPGAs), controllers, micro-controllers, microprocessors, and/or other electrical units for performing functions or a plurality of electrically connected processors.

In particular, in some embodiments, the processor 131 may be configured based on a field programmable gate array (FPGA) implementation and/or an application specific integrated circuit (ASIC) which are hardware technologies for implementing a certain digital circuit. A detailed description of this will be omitted since the foregoing description of FPGA and ASIC can apply.

In addition, the memory 132 may include one or more non-transitory and/or transitory computer-readable storage media such as RAM, ROM, EEPROM, EPROM, flash memory devices, and magnetic disks, and combinations thereof. The memory 132 may store data 133 and instructions 134 required for or executable by the processor 131 to perform a functional operation such as training an artificial intelligence model or implementing an asset portfolio prediction service through the artificial intelligence model.

In one embodiment, the server computing system 130 may be implemented to include at least one computing device or computer. For example, the server computing system 130 may be implemented to operate a plurality of computing devices according to a sequential computing architecture, a parallel computing architecture, or a combination thereof. Additionally, the server computing system 130 may include a plurality of computing devices connected via the network 170.

The server computing system 130 may store at least one machine learning model 140. For example, the server computing system 130 may include, as the machine learning model 140, a neural network and/or other multi-layer nonlinear models. Exemplary neural networks may include feed-forward neural networks, deep neural networks, recurrent neural networks, and convolutional neural networks.

In an embodiment, the server computing system 130 may further include a data store computing system (hereinafter, “data store”), which serves as a repository for continuously storing and managing raw data that forms the basis of the asset portfolio prediction service.

The data store may include various types of data storage, from file systems to cloud storage. For example, the data store may include at least one of the following types of databases: a relational database that uses Structured Query Language (SQL) to define and manipulate data; a NoSQL database designed for flexibility and scalability to handle unstructured and semi-structured data; a data warehouse which is a system used for reporting and data analysis, optimized for querying and analysis since large volumes of data from multiple sources are centralized; a data warehouse which stores massive amounts of raw data in its native formats, including structured, semi-structured, and unstructured data; and local storage devices or network attached storage (NAS) which generally store data in file formats accessible by computer operating systems.

### —Training Computing System 150

The training computing system 150 includes at least one processor 151 and memory 152.

Here, the processor 161 of the training computing system 150 may include at least one of a central processing unit (CPU), graphics processing unit (GPU), application-specific integrated circuits (ASICs), digital signal processors (DSPs), digital signal processing devices (DSPDs), programmable logic devices (PLDs), field-programmable gate arrays (FPGAs), controllers, micro-controllers, microprocessors, and/or other electrical units for performing functions or a plurality of electrically connected processors.

In particular, in some embodiments, the processor 151 may be configured based on a field programmable gate array (FPGA) implementation and/or an application specific integrated circuit (ASIC) which are hardware technologies for implementing a certain digital circuit. The detailed description of this will be omitted since the foregoing description of FPGA and ASIC can apply.

In addition, the memory 152 may include one or more non-transitory and/or transitory computer-readable storage media such as RAM, ROM, EEPROM, EPROM, flash memory devices, and magnetic disks, and combinations thereof. The memory 152 may store data 153 and instructions 154 required for or executable by the processor 151 to train an artificial intelligence model.

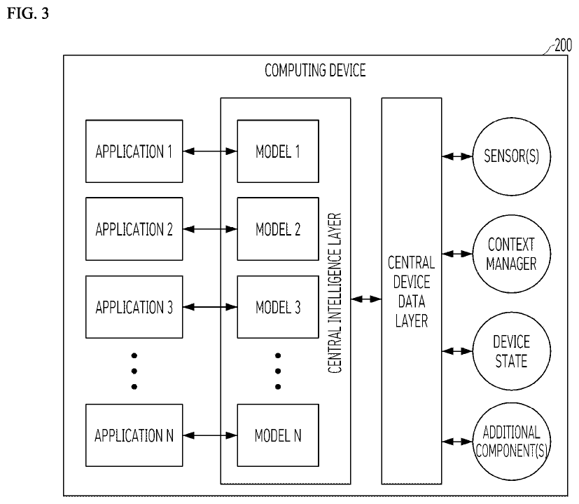

For example, the training computing system 150 may include a model trainer 160 configured to train one or more machine learning models (e.g. machine learning models 120 and/or 140) stored in the user computing device 110 and/or the server computing system 130, by using various training or learning techniques such as error backpropagation (in accordance with the framework illustrated in FIG. 3).

By way of example, the model trainer 160 may perform updates to one or more parameters of one or more machine learning models 120 and/or 140 for the asset portfolio prediction service through backpropagation based on a defined loss function.

In some implementation examples, performing error backpropagation may include performing truncated backpropagation through time. The model trainer 160 may perform a number of generalization techniques (e.g., weight decay, dropout, and/or knowledge distillation) to enhance the generalization capability of one or more machine learning models 120 and/or 140 being trained.

Moreover, the model trainer 160 may train one or more machine learning models 120 and/or 140 based on a series of training data 161. For example, the training data 161 may include different forms of data, such as images, audio samples, and/or text. Examples of images include video frames, LiDAR point clouds, X-ray images, computed tomography (CT) scans, hyperspectral images, and/or various other forms of images.

The training data 161 may be provided by the user computing device 110 and/or the server computing system 130. When the training computing system 150 trains the machine learning model(s) 120 and/or 140 on specific data from the user computing device 110, the machine learning model(s) 120 and/or 140 may be characterized as a personalized model.

Additionally, the model trainer 160 includes computer logic utilized to provide desired functionality.

Moreover, the model trainer 160 may be implemented in hardware, firmware, and/or software that controls a general-purpose processor. In one implementation example, the model trainer 160 may include program files stored on a storage device, be loaded in the memory 152, and be executed by one or more processors 151. In another implementation example, the model trainer 160 may include one or more sets of computer-executable data 153 and instructions 154 stored on a tangible computer-readable storage medium, such as RAM, hard disks, or optical or magnetic media.

The network 170 may include, for instance, but not limited to, 3GPP (3rd Generation Partnership Project) network, LTE (Long Term Evolution) network, WiMAX (World Interoperability for Microwave Access) network, Internet, LAN (Local Area Network), Wireless LAN (Wireless Local Area Network), WAN (Wide Area Network), PAN (Personal Area Network), Bluetooth network, satellite broadcasting network, analog broadcasting network, and/or DMB (Digital Multimedia Broadcasting) network.

In general, communication via the network 170 may be performed using any type of wired and/or wireless connection, through various communication protocols (e.g., TCP/IP, HTTP, SMTP, and/or FTP), encodings or formats (e.g., HTML and/or XML), and/or protection schemas (e.g., VPN, secure HTTP, and/or SSL).

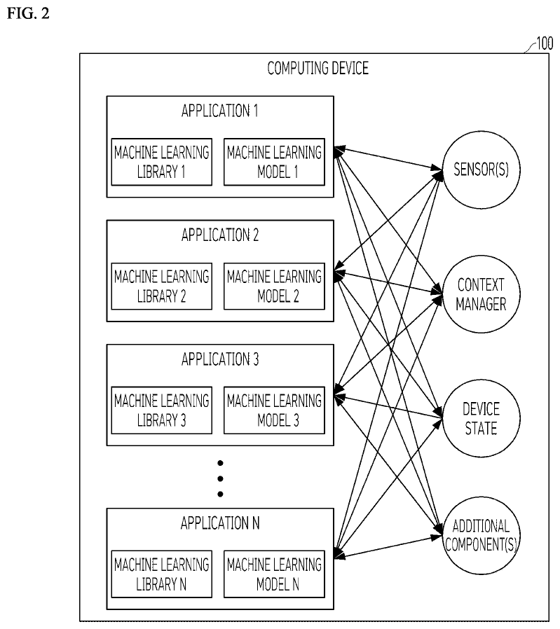

FIG. 2 illustrates a block diagram of a computing device that implements an asset portfolio prediction service according to an embodiment of the present disclosure.

Referring to FIG. 2, a computing device 100 included in the user computing device 110, the server computing system 130, and the training computing system 150 may include multiple applications (e.g., Application 1 through Application N). Each application may include a machine learning library and one or more machine learning models. For example, the applications may include applications for image processing (e.g., detection, classification, and/or segmentation), text messaging applications, email applications, dictation applications, virtual keyboard applications, browser applications, and/or chat-bot applications.

In an embodiment, the computing device 100 may include a model trainer 160 for training an artificial intelligence model, and may provide output data based on predetermined input data by storing and running the trained artificial intelligence model.

Each application of the computing device 100 may communicate with multiple other components of the computing device 100, such as one or more sensors, a context manager, a device state component, and/or additional components. In one embodiment, each application may use an API (e.g., a public API) to communicate with each device component. In one embodiment, the API used by each application may be specific to that application.

FIG. 3 illustrates a block diagram of a computing device that implements an asset portfolio prediction service according to an embodiment of the present disclosure.

Referring to FIG. 3, the computing device 200 includes multiple applications (e.g., Application 1 to Application N). Each application may communicate with a central intelligence layer. For example, the applications may include image processing applications, text messaging applications, email applications, dictation applications, virtual keyboard applications, and/or browser applications. In one embodiment, each application may use an API (e.g., a common API shared across all applications) to communicate with the central intelligence layer (and the models stored therein).

The central intelligence layer may include multiple machine learning models. For example, as illustrated in FIG. 3, one or more of the machine learning models may be provided for each application and managed by the central intelligence layer. In another implementation example, two or more applications may share a single machine learning model. For example, in some implementation examples, the central intelligence layer may provide a single model for all applications. In some implementation examples, the central intelligence layer may be incorporated into the operating system of the computing device 200 or implemented differently.

The central intelligence layer may communicate with a central device data layer. The central device data layer may serve as a centralized data storage location for the computing device 200. As illustrated in FIG. 3, the central device data layer may communicate with multiple other components of the computing device 200, such as one or more sensors, a context manager, a device state component, and/or additional components. In some implementation examples, the central device data layer may use an API (e.g., a private API) to communicate with each device component.

The technologies and components described herein may be applied and make reference to servers, databases, software applications, and other computer-based systems, as well as actions taken and information transmitted to or from the above systems. It will be appreciated that the inherent flexibility of computer-based systems allows for a wide range of possible configurations, combinations, divisions of tasks, and functionality between and from components. For example, the processes described herein may be implemented using a single device or component, or multiple devices or components working in combination. Databases and applications may be implemented on a single system or distributed across multiple systems. Distributed components may operate sequentially or in parallel.

### [Asset Portfolio Prediction Method]

Hereinafter, a method in which the computing system 1000 according to an embodiment of the present disclosure predicts asset portfolio weights based on adjustable objectives and diversified data (i.e., a method for implementing an asset portfolio prediction service) will be described in detail with reference to the accompanying drawings.

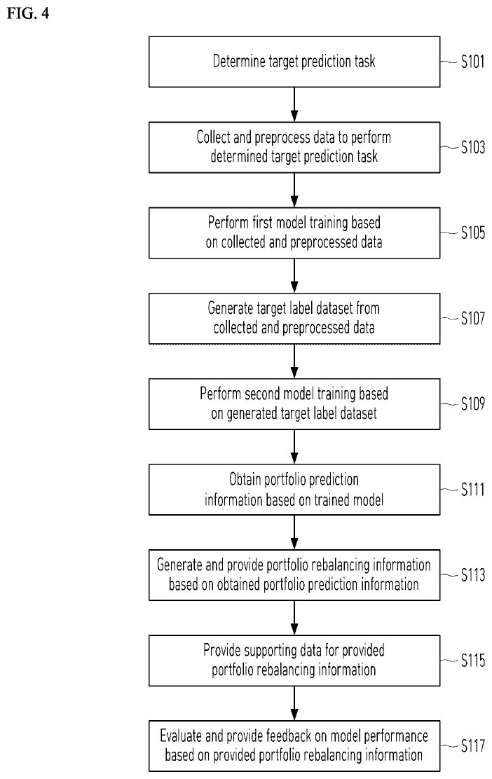

FIG. 4 illustrates a flowchart for explaining an asset portfolio prediction method according to an embodiment of the present disclosure.

Referring to FIG. 4, an asset portfolio prediction method according to an embodiment of the present disclosure may include: one or more steps of step (S101) of determining a target prediction task; step (S103) of collecting and preprocessing data to perform the determined target prediction task; step (S105) of performing first model training based on the collected and preprocessed data; step (S107) of generating a target label dataset from the collected and preprocessed data; step (S109) of performing second model training to train a time-series prediction model based on the generated target label dataset; step (S111) of obtaining portfolio prediction information based on the trained time-series prediction model; step (S113) of generating and providing portfolio rebalancing information based on the obtained portfolio prediction information; step (S115) of providing supporting data for the provided portfolio rebalancing information; and/or step (S117) of analyzing the outcomes of the provided portfolio rebalancing information to evaluate and provide feedback on the performance of the time-series prediction model.

At step S101, the computing system 1000 according to an embodiment of the present disclosure may determine a target prediction task.

The target prediction task according to the embodiment may be data that specifies a target task intended to be performed, and may comprise a task of predicting the weights of portfolio assets for a predetermined first domain.

In an embodiment, the computing system 1000 may obtain various types of data (hereinafter, task configuration information) required to determine the target prediction task, according to a predetermined manner.

The task configuration information according to an embodiment may include a predetermined first domain, current portfolio asset weights or investment amounts, an entire forecasting period, a prediction unit period (e.g., a rebalancing period), an asset pool, and/or investment style data.

Here, the investment style according to an embodiment may include: a return-maximizing style, which allocates weights to assets with positive(+) historical cumulative returns based on the portfolio's expected return calculated by Equation 1 below; a risk-minimizing style, which allocates weights to assets with low historical volatility based on the portfolio volatility calculated by Equation 2 below; and a Sharpe ratio-optimizing style, which allocates weights in descending order of asset-specific Sharpe ratios based on the Sharpe ratio calculated by Equation 3 below.

$$\begin{matrix}[ Equation 1 ] & \\ E ( {R}_{P} ) = \frac{1}{τ} {\sum }_{t = 1}^{τ} {R}_{P , t} & ( 1 )\end{matrix}$$

$$E ( {R}_{P} ) = {\sum }_{i}^{N} {w}_{i , t - 1} \times {r}_{i , t} - C \times {\sum }_{i}^{N} \vert {w}_{i , t - 1} - {w}_{i , t - 2} \vert \qquad ( 2 )$$

In Equation 1, E(R_{P}) denotes the average portfolio return over a specific period, τ denotes the length of the trading period, R_{P,t} denotes the portfolio return at a given time point t, adjusted for transaction costs, N denotes the total number of assets included in the portfolio, w_{i,t-1} denotes the weight of an i-th asset at time point (day) t−1, r_{i,t} denotes the realized arithmetic return of the i-th asset from time point t−1 to time point t, and C denotes the transaction cost rate (fee) constant (e.g., 0.002%).

$$\sqrt{E ( {R}_{P}^{2} ) - {( E ( {R}_{P} ) )}^{2}} \qquad Equation 2$$

In Equation 2, E(R_{P}) denotes the expected portfolio return (see Equation 1, and E(R_{P}²) denotes the expected value of the squared portfolio return.

$$S R = \frac{E ( {R}_{P} )}{\sqrt{E ( {R}_{P}^{2} ) - {( E ( {R}_{P} ) )}^{2}}} \qquad Equation 3$$

In Equation 3, SR denotes the Sharpe ratio, which may refer to the value obtained by dividing the expected portfolio return calculated by Equation 1 by the portfolio volatility calculated by Equation 2.

More specifically, in an embodiment, the computing system 1000 may obtain user input that specifies the task configuration information by utilizing a user interface including a predefined input template and/or a large language model (LLM)-based interaction model.

In this case, in some embodiments, the computing system 1000 may analyze the conversational context of an interaction model-based user input and identify the task configuration information, the elements necessary for determining a target prediction task, and/or the objective based on the analyzed context.

Moreover, in some embodiments, the computing system 1000 may generate additional queries based on the analyzed context to further obtain additional necessary data (e.g., data that specifies the elements necessary for determining the target prediction task).

Furthermore, in an embodiment, the computing system 1000 may determine the target prediction task based on the obtained user input.

For example, the computing system 1000 may determine a target prediction task that predicts portfolio asset weights for a first domain specified in task configuration information obtained from given user input, by reflecting the investment style specified in the task configuration information over the prediction unit period (e.g., a rebalancing period) specified in the task configuration information.

As such, in an embodiment, the computing system 1000 may determine the target prediction task based on user input obtained through various methods (e.g., methods based on a user interface including a predetermined input template and/or a large language model (LLM)-based interaction model). Thus, by configuring a target prediction task that accurately reflects the user's intent, the computing system 1000 can enhance the efficiency and prediction accuracy of subsequent data collection and model training phases.

At step S103, the computing system 1000 according to an embodiment of the present disclosure may perform data collection and pre-processing to perform the determined target prediction task.

That is, in an embodiment, the computing system 1000 may collect and preprocess various types of raw data necessary to perform the target prediction task.

Hereinafter, for effective explanation, the entire forecasting period is denoted by T, a given time point within the forecasting period is denoted by t, a time in the past that precedes the given time point t by a period p is denoted by (t-p), and a time in the future that comes after the given time point t by a given period h is denoted by (t+h).

The period p and/or the period h may be set according to a predetermined method (e.g., based on user input and/or a specific optimization algorithm), or may be set based on the prediction unit period (e.g., a rebalancing period) for the target prediction task.

Furthermore, for effective explanation, each period will be described based on days.

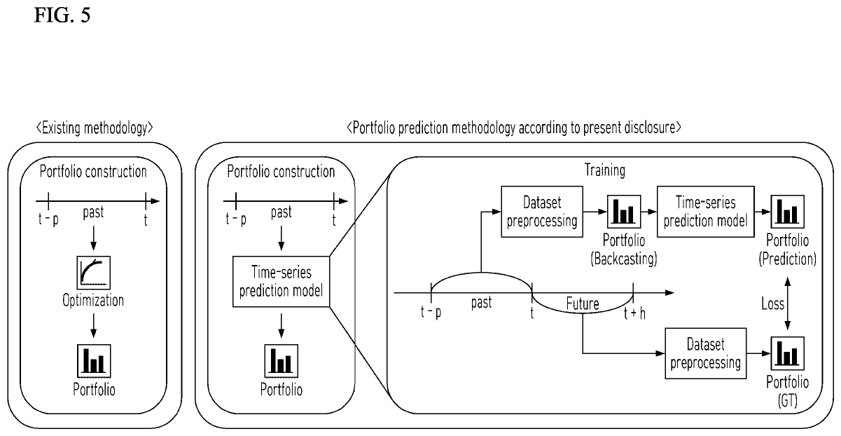

FIG. 5 illustrates a conceptual diagram of a time-series prediction model-based portfolio prediction method according to an embodiment of the present disclosure and a conventional portfolio construction method.

Referring to FIG. 5, in an embodiment, the computing system 1000 may collect raw data from time point (t−p) to time point (t−1).

More specifically, the computing system 1000 may collect time-series price data of each asset included in a preset asset pool, including high, low, and close prices, trading volume, etc.

Additionally, the computing system 1000 may collect macroeconomic indicator data, including key macroeconomic indicators such as WTI crude oil prices, U.S. treasury yields, interest rates, inflation rates, and GDP growth rates.

Furthermore, the computing system 1000 may collect market indicator data, including volatility indices (VIX) and overall market indices.

In some embodiments, the computing system 1000 may detect target-influencing variables, which are variables correlated with the target prediction task.

For example, the computing system 1000 may detect target-influencing variables that have a correlation of a predetermined value or higher with the first domain and/or assets corresponding to the target prediction task.

In addition, the computing system 1000 may collect raw data corresponding to the detected target-influencing variables (hereinafter, target-influencing variable data).

To this end, the computing system 1000 may collect target analysis reports by utilizing a large language model (LLM) or a keyword search engine based on keywords representing the first domain of the target prediction task.

Moreover, the computing system 1000 may define the target-influencing variables from the collected target analysis reports at a semantic level and extract causal relationships between the defined variables and the weights thereof.

In addition, the computing system 1000 may obtain target-influencing variable data from the target analysis reports by reflecting the extracted causal relationships and weights.

In an embodiment, the computing system 1000 may also align the collected raw data

(e.g., time-series price data, macroeconomic indicator data, market indicator data, and/or target-influencing variable data) on the same time axis.

In this case, in some embodiments, the computing system 1000 may apply a sliding window approach to align raw data collected at various points in time on a specific time axis.

Here, the sliding window approach according to an embodiment may refer to a process in which a fixed-length time window is moved at regular intervals to extract and align the data contained within each window.

The specific time axis according to an embodiment may be variably configured depending on the characteristics of the data and the purpose of the analysis.

In one example, the time axis may be based on days. In this case, monthly indicator values may be assigned equally to all trading days within the corresponding month, in order to process both daily collected asset price data and macroeconomic indicators released on a monthly or quarterly basis. Additionally, a forward-filling method may be employed in which the data from the most recent trading day is carried forward for time points where data is unavailable, such as weekends or public holidays, thereby ensuring the continuity of data.

As another example, the time axis may be based on weeks to facilitate mid-term analysis. In this case, daily collected price data can be aggregated into weekly data according to specific rules, such as using the closing price of the last trading day of each week. Monthly released data may be assigned equally to all weeks included within the corresponding month for alignment purposes.

As yet another example, the time axis may be based on months to analyze long-term trends or mitigate the impact of short-term market noise. In this case, daily or weekly data may be converted into monthly data based on the closing price of the last trading day of each month. Indicators released on a quarterly basis, such as GDP growth rates, may be applied equally to all three months within the corresponding quarter to maintain consistency along the time axis.

In this manner, the computing system 1000 can support the subsequent time-series prediction model in performing stable learning and prediction based on consistent data by aligning all input data on a specific time axis that aligns with the analysis purpose.

Accordingly, in an embodiment, the computing system 1000 may generate raw feature data by aligning various raw data from time point (t−p) to time point (t−1) along a consistent time-series axis.

In this case, according to an embodiment, the computing system 1000 may align the task configuration information on the time-series axis, along with the generated raw feature data.

As such, in an embodiment, by obtaining raw feature data which is diversified internal and external data arranged in a consistent time-series, the computing system 1000 can prepare objective and stable training data that enhances the efficiency and prediction accuracy of subsequent model training, thereby effectively helping resolve the numerical instability problem in the inversion of the covariance matrix and the problem of accumulation of prediction errors from the past which occur in traditional mean-variance optimization (MVO) methods.

At step S105, referring further to FIG. 5, the computing system 1000 according to an embodiment of the present disclosure may perform first model training based on the collected and preprocessed data.

In detail, in an embodiment, the computing system 1000 may perform first-model training to use a predetermined time-series prediction model, by using the collected and preprocessed raw feature data and the task configuration information corresponding to the target prediction task (hereinafter, a “first model training dataset”) to train a predetermined time-series prediction model.

For example, the time-series prediction model according to an embodiment may include a temporal fusion transformer (TFT)-based deep learning model (hereinafter, TFT model).

In this case, unlike conventional prediction models (e.g., traditional mean-variance optimization models but not transformer-based ones, pre-trained statistical regression models, or machine learning models only capable of handling limited input features), the TFT model can simultaneously accept and process various types of categorical and continuous inputs such as a predetermined portfolio asset ratio, daily returns by asset, macroeconomic indicators, market indicators, and/or target-influencing variables. Through its self-attention mechanism, it autonomously selects important time points and features within the time series, and effectively encodes past observations of variable length.

Based on this, the time-series prediction model according to an embodiment may be a temporal fusion transformer-based deep learning model which takes various forms of data such as those described above as input features and produces a time series of portfolio asset weights for predetermined future points in times as output features in response to the input features.

In contrast, the conventional prediction models may be pre-trained machine learning models and/or statistical regression models but not transformer-based ones, and may be deep learning models that are limited in that they can only process a small, predetermined number of input features and operate under fixed parameter settings.

However, in an embodiment of the present disclosure, the time-series prediction model may be a model capable of handling much richer and more diverse input features compared to conventional prediction models. Accordingly, it may provide more sophisticated and reliable prediction results for portfolio asset weights.

In an embodiment, the computing system 1000 may (1) input time-series interval data from time point (t−p) to time point t, among the raw feature data included in the first model training dataset, into the time-series prediction model.

In an embodiment, the computing system 1000 may select multiple training samples from the entire raw feature data using a windowing method, the training samples being segmented based on a predetermined time interval (e.g., a rebalancing period), and may sequentially feed each selected sample into the time-series prediction model.

In this case, the input samples each may include a predetermined portfolio asset ratio, a daily return by asset, a macroeconomic indicator, a market indicator, a target-influencing variable, and/or task configuration information. These samples may be aligned on a consistent time-series axis and provided to an encoder of the time-series prediction model.

Furthermore, in an embodiment, the computing system 1000 may (2) predict time-series data of portfolio asset weights for a time-series interval from time point (t+1) to time point (t+h), by using the time-series prediction model into which time-series interval data from time point (t−p) to time point t (hereinafter, “past input features”) has been inputted.

In this case, in an embodiment, the time-series prediction model may derive reliable predicted values for each prediction unit period (e.g., a rebalancing period) while progressively considering predetermined future points in time, by using a deep learning algorithm that includes a self-attention mechanism (e.g., multi-head self-attention) and gated skip connections.

Here, the prediction results of the time-series prediction model may be outputted in such a manner that the portfolio asset weights are represented in the form of a vector, and may be aligned by date along the time-series axis.

In an embodiment, the computing system 1000 may (3) perform normalization post-processing on the time-series data of the predicted portfolio asset weights.

In detail, in an embodiment, the computing system 1000 may perform a normalization process so that the sum of the weights of assets in each portfolio outputted by the time-series prediction model equals ‘1’.

For example, the computing system 1000 may perform normalization on the weight of each asset in the portfolio for a specific date k predicted by the time-series prediction model according to Equation 4 below.

$${\hat{w}}_{i}^{( t + k )} = \frac{{\hat{w}}_{i}^{( t + k )}}{{\sum }_{j = 1}^{N} {\hat{w}}_{j}^{( t + k )}} \qquad [ Equation 4 ]$$

Through this, in an embodiment, the computing system 1000 may provide result data that satisfies a fully invested condition in which the entire portfolio asset class is wholly and reasonably invested.

In an embodiment, the computing system 1000 may (4) perform a comparison between predicted data and actual data.

The computing system 1000 may compare output values for a prediction interval from time point (t+1) to time point (t+h) on a one-to-one basis against actual time-series data of portfolio asset weights in the first model training dataset that corresponds to the same prediction interval from time point (t+1) to time point (t+h).

In an embodiment, the computing system 1000 may (5) perform loss calculation and performance evaluation based on the comparison results.

In an embodiment, the computing system 1000 may calculate the differences between the predicted values of the time-series prediction model and the actual values by using a defined loss function, such as mean squared error (MSE).

The computing system 1000 may then evaluate the current performance of the time-series prediction model based on the calculated differences.

In this case, the computing system 1000 may aggregate the loss values calculated for each training sample to monitor the model's performance throughout the entire epoch.

In an embodiment, the computing system 1000 may (6) perform model updates based on the calculated loss values.

In detail, in an embodiment, the computing system 1000 may update the parameters of the time-series prediction model by using a predetermined optimization technique (e.g., Adam optimizer) to minimize the calculated losses.

In some embodiments, the computing system 1000 may repeat the above processes on an epoch-by-epoch basis, and if a predetermined condition (e.g., a condition for early stopping) is satisfied, the computing system 1000 may terminate training at a corresponding optimal point and finalize optimal model parameters.

Accordingly, in an embodiment, the computing system 1000 may perform first model training to train the time-series prediction model by using a first model training dataset that includes raw feature data and task configuration information.

In this way, in an embodiment, the computing system 1000 may perform first model training to train the time-series prediction model so that its output follows the target labels of the first model training dataset, by predicting the time-series of portfolio asset weights for the period from (t+1) to (t+h) based on data for a predetermined period from (t−p) to t through the time-series prediction model and updating the time-series prediction model to reduce or minimize the differences between the predicted values for the period from (t+1) to (t+h) and the actual values (e.g., the time-series of portfolio asset weights for the period from (t+1) to (t+h) in the first training dataset).

Through this, the computing system 1000 can implement a portfolio weight prediction model that eliminates numerical instability caused by covariance matrix inversion operations that arise from the prediction processes of the existing prediction models (e.g., traditional mean-variance optimization-based models), reduces or minimizes the accumulation of prediction errors, and flexibly integrates various external indicators to respond promptly to market changes.

Moreover, in an embodiment, the computing system 1000 can implement a time-series prediction model that maintains stability and scalability not only for small-scale assets at the sector level but also for large-scale asset classes such as the S&P 500, while achieving desired objectives (e.g., maximizing returns, minimizing risks, and/or optimizing Sharpe ratios).

Accordingly, the computing system 1000 may overcome the limitations of the existing optimization methods and provide a more reliable dynamic asset allocation solution in real-world investment environments.

At step S107, the computing system 1000 according to one embodiment of the present disclosure may generate a target label dataset based on the collected and preprocessed data.

Here, the target label dataset according to an embodiment may refer to data of the portfolio asset weights for each day within a predetermined prediction period (e.g., the period from (t+1) to (t+h)), predicted by an existing prediction model.

That is, in an embodiment, the target label dataset may be data of portfolio asset weights generated by an existing prediction model, corresponding to each day included in the prediction period of the time-series prediction model.

In an embodiment, the target label dataset described above may be utilized as the target data for subsequent second model training based on the time-series prediction model.

In detail, in an embodiment, the computing system 1000 may (1) generate summary indicators for each asset using source data collected over a predetermined past period (e.g., the period from (t−p) to t).

The source data according to an embodiment may refer to fundamental data collected to calculate the outcomes and risk level of portfolio assets, such as asset-specific time-series price data (e.g., high, low, closing prices), trading volume data, and/or volatility indices (e.g., VIX).

In an embodiment, the computing system 1000 may obtain the source data using various methods, such as by extracting source data from the above raw data (or raw feature data) or by collecting raw data via interoperation with a predetermined external server.

Additionally, the summary indicators according to an embodiment may comprise representative statistical indicators calculated based on the source data—for example, average returns for assets, volatility or variance of returns, correlations or covariance of assets, and/or Sharpe ratios indicating returns compared to risk.

In an embodiment, the computing system 1000 may calculate each summary indicator from the source data collected from time point (t−p) to time point t, by using preset calculation algorithms for different summary indicators.

For example, the computing system 1000 may calculate daily returns by asset based on time-series price data of each asset, then calculate cumulative returns, average returns, standard deviations or volatility, and/or correlation coefficients between assets over a given period based on the calculations, and then derive the Sharpe ratio indicating the return compared to risk for each asset by using the calculated data values.

Furthermore, in an embodiment, the computing system 1000 may generate objective-specific target label datasets based on the calculated summary indicators.

Here, the objective-specific target label datasets according to an embodiment may refer to datasets that match specific measurable objectives (e.g., investment styles and/or market conditions), respectively, generated by using existing prediction models optimized for these objectives.

That is, in an embodiment, the computing system 1000 may generate target label datasets (e.g., objective-specific target label datasets) optimized for different objectives, by using existing prediction models with high prediction accuracy tailored to specific investment styles (e.g., return maximization, risk minimization, Sharpe ratio optimization, etc.) and/or market conditions (e.g., bull market, bear market, correction phase, etc.).

In detail, in an embodiment, the computing system 1000 may detect a summary indicator corresponding to a preset input feature for each existing prediction model and feed the detected summary indicator into the corresponding existing prediction model as an input feature.

In one example, the computing system 1000 may feed a corresponding input feature (e.g., a predetermined first summary indicator or the like) into a corresponding existing prediction model optimized to have a predetermined level of prediction accuracy or higher for a first investment style (e.g., return maximization), thereby generating a first target label dataset tailored to the first investment style.

In another example, the computing system 1000 may feed a corresponding input feature (e.g., a predetermined second summary indicator or the like) into a corresponding existing prediction model optimized to have a predetermined level of prediction accuracy or higher for a second investment style (e.g., risk minimization), thereby generating a second target label dataset tailored to the second investment style.

In yet another example, the computing system 1000 may feed a corresponding input feature (e.g., a predetermined third summary indicator or the like) into a corresponding existing prediction model optimized to have a predetermined level of prediction accuracy or higher for a third investment style (e.g., Sharpe ratio optimization), thereby generating a third target label dataset tailored to the third investment style.

In a further example, the computing system 1000 may feed a corresponding input feature (e.g., a predetermined fourth summary indicator or the like) into a corresponding existing prediction model optimized to have a predetermined level of prediction accuracy or higher for a first market condition (e.g., bull market), thereby generating a fourth target label dataset tailored to the first market condition.

In a further example, the computing system 1000 may feed a corresponding input feature (e.g., a predetermined fifth summary indicator or the like) into a corresponding existing prediction model optimized to have a predetermined level of prediction accuracy or higher for a second market condition (e.g., bear market), thereby generating a fifth target label dataset tailored to the second market condition.

In a further example, the computing system 1000 may feed a corresponding input feature (e.g., a predetermined sixth summary indicator or the like) into a corresponding existing prediction model optimized to have a predetermined level of prediction accuracy or higher for a third market condition (e.g., correction phase), thereby generating a sixth target label dataset tailored to the third market condition.

In some embodiments, the computing system 1000 may select one investment style from among various investment styles and one market condition from among various market conditions, detect an existing prediction model optimized for both the selected investment style and market condition, and generate a target label dataset optimized for the selected investment style and market condition by feeding a predetermined input feature into the detected existing prediction model.

Additionally, in some embodiments, the computing system 1000 may determine an existing prediction model for generating a target label dataset based on the investment style data specified in the task configuration information and/or the market indicator data included in the raw feature data, extract an input feature (e.g., a predetermined summary indicator) matching the determined prediction model, and feed it into the corresponding existing prediction model to generate a target label dataset that suits the user's needs.

In this case, in an embodiment, the computing system 1000 may consistently link asset information with a target label dataset outputted by an existing prediction model, by mapping the index of each summary indicator vector one-to-one to a specific asset based on predefined asset pool information.

As such, in an embodiment, the computing system 1000 may generate target label datasets that suit various investment styles and/or market conditions using given data, and selectively utilize them when training a time-series prediction model later, thereby allowing for easier and more flexible training of time-series models for implementing predictions optimized for the user's investment goal and/or market environment.

At step S109, the computing system 1000 according to one embodiment of the present disclosure may perform second model training to train a time-series prediction model based on the generated target label dataset.

In detail, in an embodiment, the computing system 1000 may perform second model training to optimize a time-series prediction model for a specific objective using objective-specific target label datasets generated as above (e.g., optimum target label datasets that are generated for different objectives by using existing prediction models with high prediction accuracy tailored to specific investment styles (e.g., return maximization, risk minimization, Sharpe ratio optimization, etc.) and/or market conditions (e.g., bull market, bear market, correction phase, etc.)).

In detail, in an embodiment, the computing system 1000 may (1) determine a target label dataset corresponding to the user's task objective, based on task configuration information and/or raw feature data

Here, the user's task objective according to an embodiment may define a task of predicting portfolio asset weights up to a specific time, based on the investment style that suits the user's needs, the market condition, and/or the domain.

More specifically, in an embodiment, the computing system 1000 may detect a target label dataset corresponding to the user's desired task objective from among the target label datasets generated for different specific objectives (e.g., objective-specific target label datasets), based on the task configuration information and/or raw feature data.

Specifically, in an embodiment, the computing system 1000 may identify the user's task objective by analyzing the investment style data and/or market indicator data included in the task configuration information and/or raw feature data.

By way of example, the computing system 1000 may identify that the user's task objective is to predict the weights of portfolio assets for a predetermined first domain up to a specific time (e.g., rebalancing time), under the condition that the user's investment style is “return maximization” and the market condition is a “bull market.”

Furthermore, in an embodiment, the computing system 1000 may detect a target label dataset that best suits the user's identified task objective at a certain level or higher.

For example, the computing system 1000 may detect a target label dataset generated by an existing prediction model optimized for “return maximization-bull market” as a dataset that best suits the user's task objective.

In addition, in an embodiment, the computing system 1000 may determine the detected target label dataset as the target label dataset.

In this case, in some embodiments, the computing system 1000 may verify whether the determined target label dataset aligns with the user's actual task objective, via an interactive user interface and/or prompt-based Q&A, and may support modification or re-determination of the target label dataset if necessary.

Furthermore, in an embodiment, the computing system 1000 may (2) perform a comparison between the determined target label dataset and the prediction data from the time-series prediction model.

In detail, in an embodiment, the computing system 1000 may compare the daily portfolio asset weight data from time point (t+1) to time point (t+h) included in the determined target label dataset (e.g., the target label dataset optimized for learning the user's task objective) and the daily portfolio asset weight data from time point (t+1) to time point (t+h) predicted by the time-series prediction model by matching them against each other on a daily, one-to-one basis.

In this case, the prediction data from the time-series prediction model may be data that has undergone normalization post-processing applied to the time-series model's predicted values (refer to the description of step S105).

Furthermore, in an embodiment, the computing system 1000 may (3) perform loss calculation and performance evaluation based on the comparison results.

In an embodiment, the computing system 1000 may quantitatively calculate the differences between the time-series prediction model's predicted data and the target label dataset using a defined loss function, such as mean squared error (MSE).

The computing system 1000 may then evaluate the current performance of the time-series prediction model based on the calculated differences.

In this case, the computing system 1000 may aggregate the loss values calculated for each training sample to monitor the model's performance throughout the entire epoch.

Furthermore, in an embodiment, the computing system 1000 may (4) perform model updates based on the calculated loss values.

In detail, in an embodiment, the computing system 1000 may perform second model training to train the time-series prediction model such that its predicted values follow the target label dataset, based on the calculated differences.

Specifically, in an embodiment, the computing system 1000 may update the internal parameters of the time-series prediction model in a direction that reduces or minimizes the calculated loss values, using a predetermined optimization technique (e.g., Adam optimizer, RMSprop, etc.).

In this case, in an embodiment, the computing system 1000 may repeatedly perform training on an epoch basis until the loss value converges to a certain level or below or a preset condition for early stopping is satisfied.

Accordingly, in an embodiment, the computing system 1000 may perform second model training to train the time-series prediction model in such a way as to achieve prediction performance optimized for a specific objective, such as the user's investment goal and/or the current market condition, by updating the parameters of the time-series prediction model based on a target label dataset that aligns with the specific objective.

As such, in an embodiment, the computing system 1000 may further train the time-series prediction model using a target label dataset that aligns with the user's task objective, among target label datasets generated in advance for various objectives.

Through this, the computing system 1000 may provide a time-series prediction model that performs customized portfolio weight prediction that more promptly adapts to the user's investment strategy and/or the current market condition and enhances its prediction reliability.

At step S111, the computing system 1000 according to an embodiment of the present disclosure may obtain portfolio prediction information based on the trained time-series prediction model.

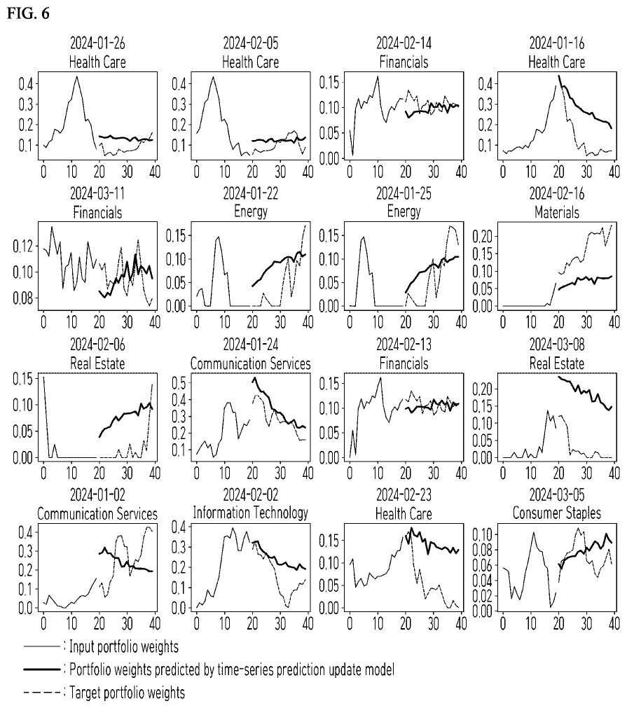

FIG. 6 illustrates examples of portfolio weight prediction results across various sectors from a time-series prediction update model according to one embodiment of the present disclosure.

Referring to FIG. 6, portfolio prediction information according to an embodiment may refer to portfolio asset weight information for a first domain which is estimated or predicted by performing the target prediction task by inputting predetermined input data (e.g., various types of categorical and continuous input features such as a predetermined portfolio asset ratio, daily returns by asset, macroeconomic indicators, market indicators, and/or target-influencing variables) into a trained time-series prediction model as described above (hereinafter, a time-series prediction update model).

In this case, the portfolio prediction information according to an embodiment may include time-series data of portfolio asset weights for each day within a predetermined prediction period (e.g., the period from (t+1) to (t+h)).

Additionally, the portfolio prediction information according to an embodiment may include portfolio asset weight data for each day that has undergone normalization post-processing (refer to the description of step S105).

In detail, in an embodiment, the computing system 1000 may (1) feed predetermined input data into the time-series prediction update model.

More specifically, in an embodiment, the computing system 1000 may obtain predetermined input data based on user input and/or a preset algorithm.

In an embodiment, the computing system 1000 may obtain various types of raw data corresponding to a predetermined period in the past (e.g., the period from (t−p) to t) as the input data.

In an embodiment, the computing system 1000 may then feed the obtained input data into the time-series prediction update model.

Furthermore, in an embodiment, the computing system 1000 may (2) predict time-series data of portfolio asset weights for a time series interval up to a predetermined point in time in the future by using the time-series prediction update model into which the input data has been fed.

In detail, in an embodiment, the computing system 1000 may predict portfolio asset weight data in a time series for each day within a period up to a predetermined future point in time (e.g., the future point in time (t+h) after a prediction unit period (e.g., a rebalancing period)) by using the time-series prediction update model.

That is, the computing system 1000 may obtain time-series data of portfolio asset weights, aligned by date on the time-series axis for the period from (t+1) to (t+h), through the time-series prediction update model.

The computing system 1000 may perform a prediction process based on the time-series prediction update model by applying model parameters optimized for first model training and/or second model training.

As such, referring further to FIG. 5, unlike conventional methodologies that estimate the return-risk structure based on predetermined input features (e.g., historical returns) and then calculate the weights of portfolio assets based on the estimated return-risk structure, the computing system 1000 in an embodiment of the present disclosure may directly predict and provide portfolio asset weights based on various forms of input data by using the time-series prediction update model according to an embodiment of the present disclosure.

That is, the computing system 1000 can directly output portfolio asset weights, through the time-series prediction update model, the portfolio asset weights that can be rebalanced without intermediate steps performed in conventional methods, thereby reducing numerical instability arising in conventional covariance matrix estimation and/or matrix inversion and minimizing or reducing cumulative errors.

Furthermore, in an embodiment, the computing system 1000 may (3) perform normalization post-processing on the time-series data of the predicted portfolio asset weights.

In detail, in an embodiment, the computing system 1000 may perform a normalization process so that the sum of the weights of assets in each portfolio predicted by the time-series prediction model equals ‘1’.

A description of a concrete method for the computing system 1000 to perform normalization post-processing will be omitted since the foregoing description of step S105 can apply.

Accordingly, in an embodiment, the computing system 1000 may perform a target prediction task for the user's task objective (e.g., investment style, market condition, and/or domain) based on predetermined input data, thereby obtaining portfolio prediction information which is result data from the prediction of daily portfolio asset weights up to a specific future point in time for a predetermined first domain.

In an embodiment, the computing system 1000 may repeatedly perform step S111 described above at each prediction unit period (rebalancing period) specified in preset task configuration information.

In this way, in an embodiment, the computing system 1000 can continuously produce and provide portfolio prediction information that reflects various input data and aligns with the user's investment goal and market changes, using the trained time-series prediction model (i.e., the time-series update model).

Accordingly, the computing system 1000 can more reliably support dynamic asset allocation by flexibly responding to the user's investment goal and market changes, while eliminating the numerical instability in the optimization process using conventional prediction models.

At step S113, the computing system 1000 according to one embodiment of the present disclosure may generate and provide portfolio rebalancing information based on the obtained portfolio prediction information.

Here, the portfolio rebalancing information according to an embodiment may refer to information that integrates, in a predetermined manner, at least one set of daily portfolio asset weight data included in the portfolio prediction information.

That is, the portfolio rebalancing information according to an embodiment may refer to a single set of portfolio asset weight data representing an entire predetermined prediction unit period (rebalancing period), obtained by processing at least one set of daily portfolio asset weight data in the portfolio prediction information, in a predetermined manner and then reconstructing it.

Accordingly, the portfolio rebalancing information may provide optimal asset weight data predicted by the time-series prediction update model at a specific point in time (e.g., the time point (t+h) after the elapse of the rebalancing period), by considering a specific objective (e.g., maximizing returns, minimizing risks, and/or optimizing Sharpe ratios).

The portfolio rebalancing information according to an embodiment may be generated and provided at each predetermined prediction unit period (rebalancing period).

In detail, in an embodiment, a processor and/or a separate processing module of the computing system 1000 may generate portfolio rebalancing information by applying preset rules to at least one set of daily portfolio asset weight data included in the portfolio prediction information.

In an embodiment, the computing system 1000 may (1) generate portfolio rebalancing information by applying a predetermined operation to the asset weights within the daily portfolio asset weight data predicted over a predetermined prediction period (rebalancing period).

Specifically, in an embodiment, the computing system 1000 may perform a predetermined operation based on the asset weights within the daily portfolio asset weight data predicted over a predetermined prediction period (rebalancing period).

By way of example, the computing system 1000 may perform an averaging operation based on the asset weights within the daily portfolio asset weight data.

Moreover, in an embodiment, the computing system 1000 may determine the integrated weight of each asset based on the result of the performed operation.

For example, the computing system 1000 may calculate the average of each asset's weights based on the performed averaging operation and use the calculated average as the final integrated weight determined for each asset.

Additionally, in an embodiment, the computing system 1000 may perform a normalization process so that the sum of the determined integrated weights of assets equals ‘1’.

For example, the computing system 1000 may perform normalization post-processing such that the sum of the integrated weights of Asset 1, Asset 2, and Asset 3 equals ‘1’.

A description of a concrete method for the computing system 1000 to perform normalization post-processing will be omitted since the foregoing description of step S105 can apply.

Accordingly, in an embodiment, the computing system 1000 may generate portfolio rebalancing information by applying a predetermined operation to the asset weights within the daily portfolio asset weight data predicted over a predetermined prediction period (rebalancing period).

In another embodiment, the computing system 1000 may (2) generate portfolio rebalancing information based on whether predefined criteria are satisfied.

In detail, in an embodiment, the computing system 1000 may select data that satisfies a preset condition (e.g., portfolio asset weight data for a date on which a particular asset attains the highest or lowest weight) from among at least one set of daily portfolio asset weight data within the portfolio prediction information.

Then, in an embodiment, the computing system 1000 may configure the selected portfolio asset weight data as the portfolio rebalancing information.

That is, in an embodiment, the computing system 1000 may detect data that satisfies a predetermined condition from among the daily portfolio asset weight data predicted over a predetermined prediction period (rebalancing period), and may utilize the detected portfolio asset weight data as a single set of portfolio asset weight data representing the rebalancing period (i.e., as the portfolio rebalancing information).

Returning to the previous discussion, in the embodiment, the computing system 1000, having generated the portfolio rebalancing information as described above, may provide the generated portfolio rebalancing information according to a predetermined method (e.g., by outputting on the display and/or by interoperating with an external application service).

In the embodiment, the computing system 1000 may integrate the above-described portfolio rebalancing information into a user interface of a robo-advisor service or an automated or algorithm-driven advisor, thereby recommending and providing personalized portfolio rebalancing information based on predetermined portfolio asset weight data.

In such cases, the computing system 1000 may generate differentiated advisory messages containing a recommended rebalancing time and asset-specific trading weights by making reference to profile data regarding the user's risk preference, investment horizon, transaction costs, and deliver these messages to the user in the form of a dashboard or a mobile notification.

Through this, the user can intuitively understand and immediately execute a rebalancing strategy optimized for them.

In another embodiment, the computing system 1000 may interoperate with a fund management support system to obtain what-if scenarios based on user input, assuming changes in specific macroeconomic indicators (e.g., GDP growth rate and/or interest rate fluctuations) or market indicators (e.g., S&P 500 fluctuation rate). For example, the fund management support system according to an embodiment of the present disclosure may be configured as a server-grade computing device comprising at least one hardware processor, a memory, and a network interface. The fund management support system may include an input unit configured to receive ‘what-if scenario’ parameters via a user interface, a high-performance calculator configured to re-execute a time-series prediction model in real-time based on the obtained parameters, and a communicator configured to transmit modified asset weight data to an external trading system or an administrator terminal. Further, the fund management support system is not a mere collection of software algorithms but may be implemented on a dedicated hardware architecture designed for parallel processing of large-scale financial data.

In addition, the computing system 1000 may re-execute a time-series prediction update model based on obtained scenario parameters to newly generate modified portfolio asset weight data and its corresponding supporting data and transmit this data in real time to the fund management support system, thereby enabling the portfolio manager to immediately verify the effects of rebalancing in a simulated environment and reflect them in decision-making.

In another embodiment, the computing system 1000 may be configured to include specific investment themes (e.g., green energy and/or healthcare) and/or factors (e.g., low volatility and/or high dividend) when setting the target prediction task.

In this case, the computing system 1000 may utilize predetermined portfolio asset weight data as input for determining the constituent portfolio of a new exchange-traded fund (ETF) product.

Specifically, the computing system 1000 may calculate the proportions of securities in an ETF's assets based on the predicted weight information and transmit these to an ETF design module to be used as a guideline for constructing a new index product.

Through this configuration process, the computing system 1000 may automatically design and propose a new ETF product optimized for market trends and user investment themes.

Returning to the previous discussion, in an embodiment, the computing system 1000 may process the daily portfolio asset weight data predicted by the time-series prediction update model into a single set of portfolio asset weight data with each predetermined rebalancing cycle. By providing such data, the system can propose optimal asset weights for an intended rebalancing time by taking into account changes and trends in the weights of portfolio assets, predicted for a period from the present up to a specific point in time (e.g., rebalancing time) over which portfolio asset weights are to be predicted.

That is, in an embodiment, the computing system 1000 may provide customized portfolio asset weights that support consistent and stable asset allocation by comprehensively considering changes and trends in the predicted portfolio asset weights, thereby providing customized portfolio asset weights that can effectively respond to such situations as unexpected market risks or the like.

Accordingly, in an embodiment, the computing system 1000 may further enhance the applicability and usability of the portfolio asset weights estimated by the time-series prediction update model during the actual asset management phase.

In this case, in some embodiments, if there are certain transaction costs and/or minimum/maximum asset weight constraints, the computing system 1000 may selectively apply an additional clipping and/or smoothing operation to generate portfolio rebalancing information.

In the embodiment, the computing system 1000 may perform a clipping operation to adjust each asset's weight within a preset allowable range, to ensure that each asset in the generated portfolio rebalancing information does not go beyond the minimum or maximum weight defined for each asset.

Specifically, in an embodiment, if the calculated integrated weight of each asset is below the minimum value or above the maximum value, the computing system 1000 may clip the weight value to the minimum value or the maximum value and perform normalization preprocessing so that the sum of the adjusted weights equals ‘1’.

Through this, in an embodiment, the computing system 1000 can avoid overconcentration on or negligible allocation of a particular asset and effectively mitigate risk imbalance and liquidity issues during actual portfolio management.

Furthermore, in an embodiment, the computing system 1000 may optionally apply a smoothing operation to alleviate abrupt fluctuations in asset weights or prevent rebalancing information from being excessively sensitive to data from a specific date.

By way of example, in an embodiment, the computing system 1000 may utilize a moving average technique or an exponential smoothing technique, based on asset weight data for a recent rebalancing period, in order to smooth out abrupt fluctuations in portfolio weights. Accordingly, in an embodiment, the computing system 1000 may support the execution of a stable portfolio rebalancing strategy while minimizing transaction costs (turnover).

As such, in an embodiment, the computing system 1000 may provide portfolio rebalancing information that considers certain transaction costs and/or minimum and/or maximum weight constraints by applying additional data processing, thereby providing robust and efficient rebalancing information that better aligns with real-world investment management environments.

At step S115, the computing system 1000 according to one embodiment of the present disclosure may provide supporting data for the provided portfolio rebalancing information.

Here, the supporting data according to an embodiment may refer to data that explains the causal relationships and data flow based on which the final portfolio asset weights calculated for a predetermined prediction period (e.g., rebalancing period) are determined.

In an embodiment, the supporting data may include causal associations with key input variables, market impact factors, and/or target-influencing variables.

Specifically, in an embodiment, the computing system 1000 may generate a feature-level causal graph based on structured datasets and semantic causal information for key features (e.g., time-series price data, macroeconomic indicators, market indicators, and/or target-influencing variables) that influence the portfolio rebalancing information.

Additionally, in an embodiment, the computing system 1000 may interpret, by a predetermined causal discovery model (data-driven causal discovery model), which variables and to what extent they influenced the portfolio rebalancing information calculated as of the present time, based on data collected in the past and the causal flow within the data.

For example, the computing system 1000 may derive the influence external macroeconomic indicators-such as price fluctuations in key assets, interest rates, oil prices, and/or volatility indices (VIX)-exert on determining a weight of a specific asset class during a rebalancing period, and may use the derived influence together with the corresponding weight as supporting data.

Additionally, in an embodiment, the computing system 1000 may quantify and provide the contribution and relative influence of each variable along with the derived causal graph.

Accordingly, the computing system 1000 may offer numerical recommendations, as well as support intuitive understanding of the rationale behind the generation of the portfolio rebalancing information and the flow of the decision-making.

Additionally, in some embodiments, the computing system 1000 may provide a user input interface configured to allow adjustment of key variable values (e.g., an interest rate hike scenario and/or increased volatility in a specific sector), so as to run what-if simulations based on the provided supporting data.

In an embodiment, the computing system 1000 may update structured datasets based on a what-if scenario inputted by the user and then re-execute the aforementioned causal interpretation process to generate and provide portfolio rebalancing information and its corresponding supporting data under the altered conditions.

As such, in the embodiment, the computing system 1000 may provide not only predicted values but also data-based causal interpretations and supporting data, thereby enhancing the reliability of the provided portfolio balancing information and increasing the user's understanding and persuasiveness.

Additionally, in an embodiment, the computing system 1000 may further provide functionality to perform prediction environment change simulations as needed, thereby supporting more refined decision-making.

At step S117, the computing system 1000 according to one embodiment of the present disclosure may analyze the outcomes of the provided portfolio rebalancing information to evaluate and provide feedback on the performance of the time-series prediction model.

In detail, in an embodiment, the computing system 1000 may monitor actual investment outcomes from the provided portfolio rebalancing information and evaluate these outcomes according to various indicators.

In an embodiment, the computing system 1000 may analyze and evaluate actual investment outcome based on the portfolio rebalancing information, using indicators such as cumulative return, Sharpe ratios, maximum drawdowns, and/or risk metrics (e.g., standard deviation).

In this case, in an embodiment, the computing system 1000 may calculate performance or evaluation indicators based on the portfolio rebalancing information at each predetermined rebalancing time (e.g. cycle), and perform performance analysis and evaluation according to the calculated indicators.

In some embodiments, the computing system 1000 may flexibly adjust a performance monitoring cycle according to a given investment goal, strategy, and/or user needs.

Additionally, in some embodiments, the computing system 1000 may visualize and provide the above calculated performance or evaluation indicators in a predefined manner (e.g., a dashboard).

Furthermore, in an embodiment, the computing system 1000 may perform a feedback process to adjust the parameters and/or input feature configuration of the time-series prediction update model based on the above calculated performance or evaluation indicators.

In an embodiment, after the completion of first model training and/or second model training, the computing system 1000 may compare and analyze the differences between daily portfolio asset weights predicted over a predetermined task period by the time-series prediction update model and actual optimized weights (e.g., portfolio asset weights obtained through an existing prediction model).

The computing system 1000 may then evaluate the performance of the time-series prediction update model using analyzed data and predetermined performance or evaluation indicators, such as cumulative return, Sharpe ratio, maximum drawdown, and/or risk metrics.

In an embodiment, if a performance evaluation result meets a predetermined criterion (e.g., a specific performance or evaluation indicator is equal to or higher than a preset value), the computing system 1000 may support deployment of the time-series prediction update model in a production environment such that portfolio asset weights (e.g., portfolio rebalancing information) calculated at each rebalancing cycle are applied in a real-world investment management environment.

Conversely, if the performance evaluation result fails to meet a predetermined criterion (e.g., a specific performance or evaluation indicator is lower than a preset value), the computing system 1000 may automatically modify the parameters of the time-series prediction update model according to the user settings and/or a preset data processing algorithm, or may perform additional training.

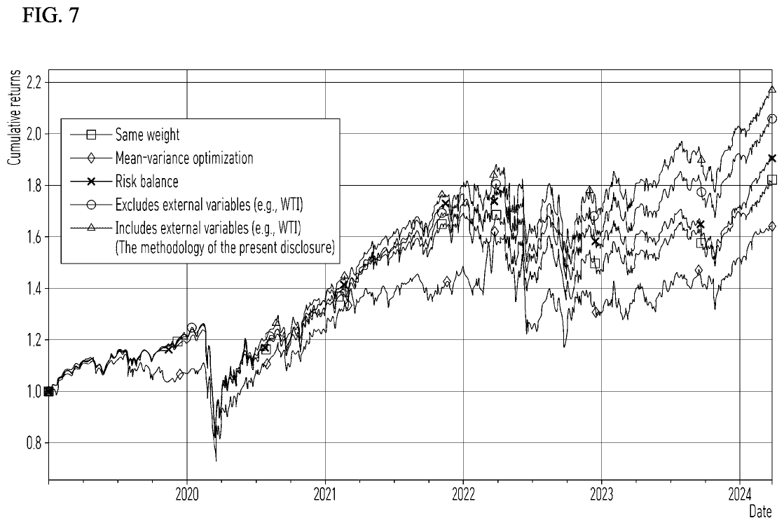

As such, in an embodiment, the computing system 1000 may continuously monitor and evaluate the performance of the time-series prediction update model and perform a feedback process based on the evaluation results. Through this, the computing system 1000 may continuously improve the prediction stability of the time-series prediction update model (e.g., a model that outputs time-series data of portfolio asset weights by considering various external indicators (variables)) and the model's alignment with the objective, thereby continuously enhancing the effectiveness and profitability of a rebalancing strategy based on this model (see FIG. 7).

As discussed above, an asset portfolio prediction method and system according to one embodiment of the present disclosure can establish and provide an optimal rebalancing strategy that flexibly responds to changes in market conditions and aligns with an investment goal, by predicting portfolio asset weights based on adjustable objectives and diversified data.

The TFT-based time-series prediction model according to an embodiment of the present disclosure may eliminate the need for matrix inversion operations of a covariance matrix, which is essentially required by the conventional mean-variance optimization (MVO) method. This can achieve technical effects of reducing computational complexity, which increases exponentially as matrix dimensions increase, and preventing processor computation errors and resource waste caused by numerical isolation or instability. In particular, by combining a self-attention mechanism with a gated skip connection, the system can optimize memory occupancy by filtering out irrelevant noise data from vast time-series data at the hardware level, and substantially enhance the processing speed of the computing system by resolving computational bottlenecks occurring during long-range dependency processing.

Furthermore, by directly outputting asset weights without an intermediate estimation of return-risk structures, the system inherently prevents error propagation associated with repetitive approximation, thereby ensuring superior numerical analytical accuracy.

Meanwhile, the embodiments of the present disclosure described above may be implemented in the form of program instructions that can be executed through various computer components and recorded on a computer-readable medium. The computer readable medium may include program instructions, data files, data structures, and the like alone or in combination. The program instructions recorded on the computer-readable recording medium may be specially designed and configured for the present disclosure, or may be known and available to those skilled in computer software. Examples of the computer-readable recording medium include: magnetic media such as hard disks, floppy disks, and magnetic tape; optical media such as CD-ROMs and DVDs; magneto-optical media such as floptical disks; and hardware devices such as ROM, RAM, and flash memory specifically configured to store and execute program instructions. Examples of the program instructions include machine language codes such as those generated by a compiler, as well as high-level language codes that can be executed by a computer using an interpreter or the like. The hardware devices may be configured to act as one or more software modules in order to perform processing according to the present disclosure, and vice versa.

The specific implementations described in the present disclosure are exemplary embodiments, and do not limit the scope of the present disclosure in any way. For brevity of the specification, descriptions of conventional electronic configurations, control systems, software, and other functional aspects of the systems may be omitted. In addition, the connections or connection members of lines between the components shown in the drawings are illustrative examples of functional connections and/or physical or circuit connections, and in actual devices, may be shown as alternative or additional various functional connections, physical connections, or circuit connections. In addition, unless specifically mentioned, such as “essential”, “importantly”, etc., the components described herein may not be necessary components for application of the present disclosure.

Furthermore, although the detailed description of the present disclosure has been provided with reference to preferred embodiments of this disclosure, those skilled in the art or having ordinary knowledge in the relevant technical field will understand that the present disclosure may be variously modified and changed without departing from the spirit and scope of the disclosure as defined in the claims that follow. Accordingly, the technical scope of the present disclosure should not be limited to the content described in the detailed description of the specification, but should be defined by the scope of the appended claims.

The present disclosure relates to a method and system for predicting asset portfolio weights through a temporal fusion transformer (TFT)-based deep learning model by utilizing adjustable objectives and diversified data, which have industrial applicability since they are applicable to the artificial intelligence industry.

What is claimed is:

1. A computer-implemented method, comprising:
determining a target prediction task comprising data specifying an objective task;
collecting raw data to perform the determined target prediction task;
aligning the collected raw data as time-series data along a time axis;
training a time-series prediction model based on the raw data aligned as the time-series data and the determined target prediction task;
predicting daily portfolio asset weight data over a predetermined prediction unit period by the trained time-series prediction model;
generating a single set of portfolio asset weight data by processing the predicted daily portfolio asset weight data at each predetermined rebalancing time; and
providing the generated single set of portfolio asset weight data.

2. The computer-implemented method of claim 1, wherein the determining of the target prediction task comprises obtaining task configuration information which includes at least two of: a predetermined domain, current portfolio asset weights, a rebalancing period, an asset pool, or investment style data.

3. The computer-implemented method of claim 2, wherein the investment style data includes data specifying at least one of: a return-maximizing tendency allocating weights to assets with positive cumulative historical returns; a risk-minimizing style allocating the weights to the assets with historical volatility; or a Sharpe ratio optimization style allocating the weights in descending order of a Sharpe ratio of each of the assets.

4. The computer-implemented method of claim 1, wherein the collecting of the raw data comprises collecting at least one of: time-series price data, macroeconomic indicator data, market indicator data, or target-influencing variable data.

5. The computer-implemented method of claim 4, wherein the target-influencing variable data comprises variables having a correlation of a predetermined value or higher with at least one of a domain or asset data corresponding the target prediction task.

6. The computer-implemented method of claim 2, wherein the aligning of the collected raw data as the time-series data along the time axis comprises aligning the task configuration information corresponding to the target prediction task on the time axis together with the raw data.

7. The computer-implemented method of claim 6, wherein the training of the time-series prediction model comprises:
inputting, into the time-series prediction model, time-series data corresponding to a period from a first time point to a second time point, from a training dataset including the raw data aligned as the time-series data and the task configuration information;
predicting the daily portfolio asset weight data for a period from a third time point to a fourth time point by the time-series prediction model into which the time-series data corresponding to the period from the first time point to the second time point has been inputted;
normalizing the predicted daily portfolio asset weight data;
comparing the normalized daily portfolio asset weight data with actual daily portfolio asset weight data from the third time point to the fourth time point;
calculating a loss based on the comparing of the normalized daily portfolio asset weight data with the actual daily portfolio asset weight data; and
updating parameters of the time-series prediction model based on the calculated loss.

8. The computer-implemented method of claim 1, wherein the predicting of the daily portfolio asset weight data over the prediction unit period comprises performing normalization post-processing on the predicted daily portfolio asset weight data so that a sum of asset weights included in the normalized daily portfolio asset weight data equals 1 (one).

9. The computer-implemented method of claim 1, wherein the generating of the single set of portfolio asset weight data comprises:
applying rules to the daily portfolio asset weight data, the rules including a first rule that applies a predetermined operation to the daily portfolio asset weight data and a second rule that determines whether the daily portfolio asset weight data satisfies a predefined criterion; and
generating the single set of portfolio asset weight data based on a result of the applying of the rules to the daily portfolio asset weight data.

10. The computer-implemented method of claim 9, wherein the generating of the single set of portfolio asset weight data comprises, when transaction costs and asset weight constraints apply, selectively applying at least one of predetermined clipping and smoothing operations to generate the single set of portfolio weight asset data.

11. The computer-implemented method of claim 1, further comprising providing supporting data for explaining which a causal relationship and data flow are used to determine the single set of portfolio asset weight data.

12. The computer-implemented method of claim 1, further comprising:
evaluating performance of the time-series prediction model based on actual investment outcomes from the single set of portfolio asset weight data; and
updating parameters of the time-series prediction model according to the evaluated performance of the time-series prediction model.

13. The computer-implemented method of claim 1, further comprising:
obtaining a target label dataset generated from daily portfolio asset weight data corresponding to a prediction period of the time-series prediction model, based on a predetermined prediction model; and
training the time-series prediction model based on the obtained target label dataset.

14. The computer-implemented method of claim 13, wherein the training of the time-series prediction model based on the target label dataset comprises:
comparing each of the daily portfolio asset weight data, from which the target label dataset is generated, with each of the daily portfolio asset weight data predicted by the time-series prediction model;
calculating a loss based on the comparing of each of the daily portfolio asset weight data, from which the target label dataset is generated, with each of the daily portfolio asset weight data predicted by the time-series prediction model; and
updating parameters of the time-series prediction model based on the calculated loss.

15. The computer-implemented method of claim 13, wherein:
the obtaining of the target label dataset comprises obtaining objective-specific target label datasets using the predetermined prediction model configured for prediction for an objective, and
the training of the time series prediction model based on the obtained target label data set comprises:
determining, among the obtained objective-specific target label datasets, a target label dataset corresponding to a task objective based on at least one of an investment style, a market condition, or a domain; and
training the time-series prediction model based on the determined the target label dataset.

16. The computer-implemented method of claim 11, further comprising:
obtaining, via user input, a what-if scenario assuming a change in a macroeconomic indicator or a market indicator; and
generating, by the time-series prediction model, a single set of modified portfolio asset weight data and modified supporting data based on the obtained what-if scenario;
providing the single set of modified portfolio asset weight data and the modified supporting data to a fund management support system.

17. The computer-implemented method of claim 1, wherein the training of the time-series prediction model comprises training the time-series prediction model comprising a temporal fusion transformer (TFT)-based deep learning model, based on the raw data aligned as the time-series data and the determined target prediction task.

18. A system comprising:
at least one memory configured to store one or more executable instructions; and
at least one processor configured to execute one or more of the instructions to perform operations comprising:
determining a target prediction task comprising data specifying an objective task;
collecting raw data to perform the determined target prediction task;
aligning the collected raw data as time-series data along a time axis;
training a time-series prediction model based on the raw data aligned as the time-series data and the determined target prediction task;
predicting daily portfolio asset weight data over a predetermined prediction unit period based on the trained time-series prediction model;
generating a single set of portfolio asset weight data by processing the predicted daily portfolio asset weight data at each predetermined rebalancing time; and
providing the generated single set of portfolio asset weight data.

19. The system of claim 18, comprising:
a plurality of neurons configured in an array including at least one register, at least one programmable logic, and at least one input interface;
a plurality of synapse circuits configured to store synapse weights for adjusting connection strength between the plurality of neurons; and
at least one routing network configured to control data flow between the plurality of neurons,
wherein each of the plurality of neurons includes a field programmable gate array (FPGA) for a predetermined artificial neural network connected to at least one other neuron via the at least routing network to configure a transmission path for the synapse weights.

20. The system of claim 18, comprising:
a plurality of neurons configured in an array including at least one register, at least one microprocessor, and at least one input; and
a plurality of synapse circuits configured to store synapse weights for adjusting connection strength between the plurality of neurons,
wherein each of the plurality of neurons includes an application specific integrated circuit (ASIC) for a predetermined artificial neural network connected to at least one other neuron via one of the plurality of synapse circuits.
